(19) United States
(12) Patent Application Publication
(10) Pub. No.: US 2025/0111033 A1
(43) Pub. Date: Apr. 3, 2025

(54) SYSTEMS AND METHODS FOR INVERTERS AND POWER SOURCES

(71) Applicant: Idealab Studio, LLC, Pasadena, CA (US)

(72) Inventor: William Tod Gross, Pasadena, CA (US)

(21) Appl. No.: 18/830,227

(22) Filed: Sep. 10, 2024

Related U.S. Application Data
(60) Provisional application No. 63/587,364, filed on Oct. 2, 2023.

(51) Int. Cl. G06F 21/44; G06F 21/60; H02J 3/38

(52) U.S. Cl. CPC G06F 21/44; G06F 21/602; H02J 3/381; H02J 2300/24; H02J 2300/28

(57) ABSTRACT

Disclosed are methods and systems that authenticate a power source. Encrypted authentication data is received purporting to be from a device associated with a power generation source at a location. A determination is made as to whether the authentication data is valid. Power quantity data purportedly generated by the power generation source is received. Configuration data associated with the power generation source and environmental data associated with the location are accessed. The configuration data and the environmental data are used to calculate a predicted power quantity data for the power generation source. The predicted power quantity data is compared with the received power quantity data to determine if they correspond. If the predicted power quantity data corresponds with the received power quantity data, and the authentication data purporting to be from the device associated with the power generation source is valid, a corresponding validation indicator is generated.

### BACKGROUND OF THE INVENTION

### Incorporation by Reference to any Priority Applications

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

### Field of the Invention

The present disclosure relates to renewable energy sources and inverters usable with renewable energy sources.

### Description of the Related Art

Conventionally, the primary energy sources for electricity generation are carbon based. For example, carbon-based sources may include hydrocarbons such as oil and gas, and biofuels. Disadvantageously, the combustion of such carbon-based sources results in the emission of carbon dioxide and other emissions that may contribute to the warming of the atmosphere and climate change.

Hence, enormous efforts have been made to promote the use of energy sources that did not result in the climate-warming emission. However, disadvantageously, the ability to verify electricity and other energy output is being generated by renewable, “clean” energy is lacking.

### BRIEF DESCRIPTION OF THE DRAWINGS

While each of the drawing figures illustrates a particular aspect for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

FIG. 1 illustrates example energy generation sites and networked systems.

FIG. 2 illustrates and example system architecture.

FIG. 3A illustrates an example photovoltaic panel.

FIG. 3B illustrates an example wind turbine architecture.

FIGS. 4 and 5 illustrate example processes.

### DETAILED DESCRIPTION

Systems and methods are described configured to determine whether energy is being generated by a renewable or other green, clean energy source.

As described herein, a renewable energy source component, such as a photovoltaic panel or wind turbine (e.g., a wind turbine generator), or an associated component such as an inverter, may have an authentication circuit (which may be embedded in a chip) configured to uniquely identify the energy source component, and which may also optionally identify the energy source component type (e.g., photovoltaic panel, wind turbine), rated energy output, efficiency, blade radius (e.g., for a wind turbine), mast height (e.g., for a wind turbine), and/or other such data. The unique identifier may be utilized to verify that energy output purported to be from a green energy source is actually from a green energy source.

As further described herein, external data, such as environmental data (e.g., cloud cover, wind speed, air density, sun intensity, etc.) may be used to verify that an amount of energy output purported to be from a green energy source comports with such environmental data. Such environmental data may be obtained from satellites, light sensors (e.g., located at a given green energy source site), wind sensors (e.g., located at a given green energy source site) and/or the like. For example, given a known size and efficiency of a photovoltaic array, knowing the expected kilowatt-hours per square meter, knowing the position of the sun, knowing the time of year, and knowing the cloud cover, a model may be used to predict the power output of the photovoltaic array (e.g., in watts). If the reported power output is more than a threshold amount greater than predicted, a determination may be made that the reported power output is not accurate and may be faked or forged reporting. On the other hand, if the reported power output is more than a threshold amount less than predicted, a determination may be made that the photovoltaic array is dirty (which would reduce the amount of light reaching the photovoltaic array cells) and hence needs remedial action, such as a cleaning.

Satellites or aerial vehicles may also be used to visually verify that a purported green energy source at a given location actually exists. For example, images may be captured of the area, the presence of any green energy source detected (e.g., using a neural network configured to perform object identification on the image), and the size of the detected green energy source may be compared against a reported size of the green energy source. If no green energy source is detected, or if the detected green energy source is of a different type or a smaller size (e.g., more than a threshold amount smaller than purported) than purported in green energy generation data provided for the location, a determination may be made that the green energy generation data is inaccurate (e.g., faked).

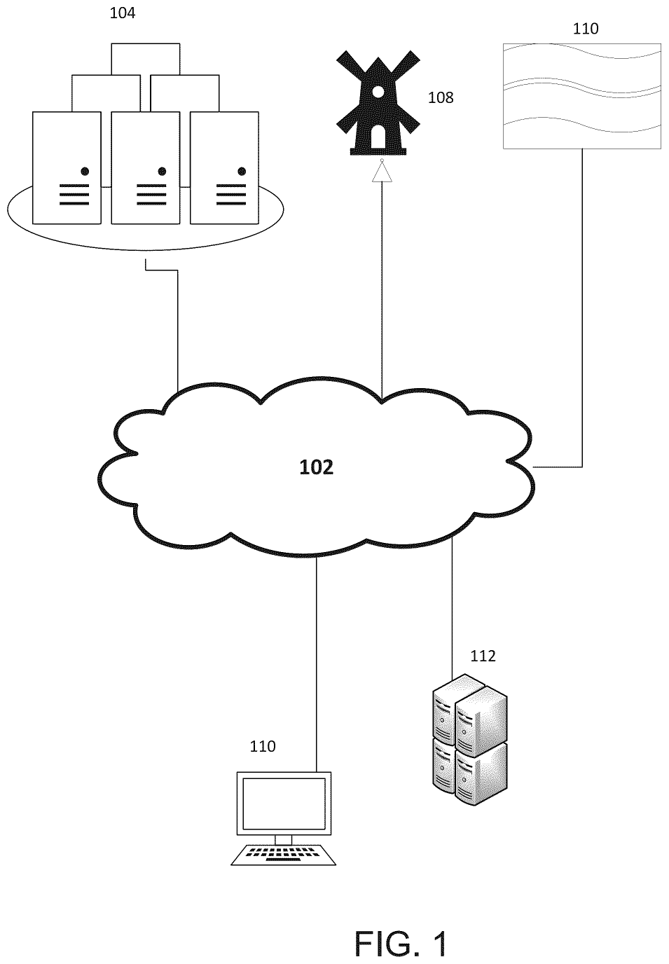

Referring now to FIG. 1, example energy generation sites and networked systems are illustrated. The sites may include (or may be purported to include) different or combinations of different types of green energy sources, such as wind generators 108 and/or solar panels 110. The sites may report green energy generation data, site data (e.g., sensor and configuration data discussed herein), and/or other data over a network 102 (e.g., the Internet, wide area network, local area network, an intranet, etc.) to an energy tracking computer system 104. The energy tracking computer system 104 may communicate over the network 102 with one or more other data sources 112, such as weather reporting services, satellite and aerial imaging services, and/or the like. One or more user terminals may be utilized to access reporting data from the sites and/or authentication status (e.g., from the energy tracking computer system 104).

The energy tracking computer system 104 may comprise a cloud system.

With respect to the cloud-based computer system implementation, the cloud-based computer system may comprise a hosted computing environment that includes a collection of physical computing resources that may be remotely accessible, located at different facilities, and may be rapidly provisioned as needed (sometimes referred to as a “cloud” computing environment). Certain data described herein may optionally be stored using a data store that may comprise a hosted storage environment that includes a collection of physical data storage devices that may be remotely accessible and may be rapidly provisioned as needed (sometimes referred to as “cloud” storage).

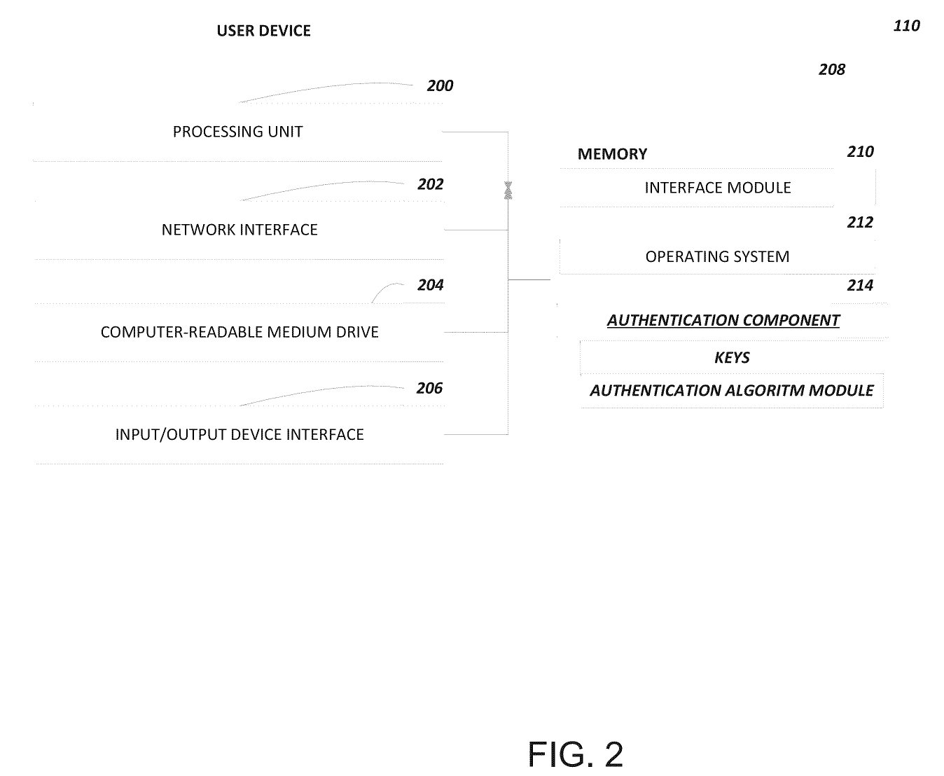

FIG. 2 is a block diagram illustrating example components of the energy tracking system 104. The example energy tracking system 104 includes an arrangement of computer hardware and software components that may be used to implement aspects of the present disclosure. Those skilled in the art will appreciate that the example components may include more (or fewer) components than those depicted in FIG. 2. Optionally, computer hardware and/or software components illustrated in FIG. 2 may be instead or also be included in other systems depicted in FIG. 1.

The energy tracking system 104 may include one or more processing units 200 (e.g., one or more general purpose processors and/or high-speed graphics processors), one or more network interfaces 202, a non-transitory computer-readable medium drive 204, and an input/output device interface 206, all of which may communicate with one another by way of one or more communication buses. The network interface 202 may provide services described herein with connectivity to one or more networks, computing systems, or other networked devices (e.g., weather reporting systems, satellite and/or aerial image storage systems, energy generation site systems, etc.). The processing unit 200 may thus receive data (e.g., energy generation data, authentication data, site configuration data, sensor data, weather data, site images, or data described herein), and/or instructions from other computing devices, systems, or services via a network, and may provide responsive data and/or execute instructions. The processing unit 200 may also communicate to and from memory 208 and further provide output information via the input/output device interface 206. The input/output device interface 206 may also accept input from one or more input devices, such as a keyboard, mouse, digital pen, touch screen, microphone, camera, etc.

The memory 208 may contain computer program instructions that the processing unit 200 may execute in order to implement one or more aspects of the present disclosure. The memory 208 generally includes RAM, ROM (and variants thereof, such as EEPROM) and/or other persistent or non-transitory tangible computer-readable storage media. An interface module 210 may provide access to data in the memory 208 and may enable data to be stored in the memory 208. The memory 208 may store an operating system 212 that provides computer program instructions for use by the processing unit 200 in the general administration and operation of an authentication component 214, including its modules.

The memory 208 may store data described herein (e.g., energy generation data, site configuration data, etc.) and/or other data. Some or all of the data and content discussed herein may optionally be stored in a relational database, an SQL database, a NOSQL database, or other database type. Optionally, the memory 208 may include one or more external third-party cloud-based storage systems.

The authentication component 214 may include a GUI component that generates graphical user interfaces (e.g., that visually displays some or all of the data discussed herein) and processes user inputs (e.g., requests for data, communications, etc.).

The authentication component 214 may receive a unique identifier and/or other data stored on a given authentication circuit associated with a given energy source component (e.g., a solar panel, an inverter, a wind turbine, etc.). The received unique identifier may be configured to uniquely identify the energy source component, and which may also identify the energy source component type (e.g., photovoltaic panel, wind turbine, etc.), rated energy output, efficiency, blade radius (e.g., for a wind turbine), mast height (e.g., for a wind turbine), a site operator/owner identifier, and/or other such data. The unique identifier may be utilized by the authentication component 214 to verify that energy output purported to be from a green energy source is actually from a green energy source. Some or all of the foregoing data may be transmitted by the authentication circuit each time an energy generation report is transmitted from the site to the system 104, at certain specified time intervals, at certain specified times of day, and/or in response to a request from the system 104.

Optionally, the authentication circuit may transmit the unique identifier in response to a challenge from the system 104. The authentication circuit may access and use a key (e.g., a public key) stored on the authentication circuit to generate an encrypted response. The authentication component 214 may decrypt the response (e.g., using a private key stored by or accessed by the authentication component 214).

Optionally, the authentication circuit may transmit the unique identifier to the system 104 (e.g., in response to a challenge from the system 104) in an encrypted communication signed using a private key stored by and associated with the authentication circuit. The communication may then be decrypted by the authentication component 214 using a public key associated with the authentication circuit (where the public key may be accessed by and/or stored by the authentication circuit.

Optionally, a key exchange process may be utilized, where the authentication circuit provides its unique set of encryption keys. These keys are used to encrypt and decrypt the transmitted data.

The authentication component 214 may optionally be configured to determine that the unique identifier is in a correct format (e.g., has the correct number of characters, and has the correct character types (e.g., alphabetic characters, numbers, special characters such as punctuation characters) at the correct location. If the unique identifier is determined to be in a correct format, the authentication component 214 may compare the received unique identifier with a set of valid unique identifiers associated with power source components. For example, a unique identifier may be added to the set of valid unique identifiers at least partly in response to the manufacture of the authentication circuit and/or in response to an initial registration process, where the authentication circuit registers its unique identifier with the system 104. If the authentication component 214 identifies a match to the received unique identifier with a unique identifier in the set of valid unique identifiers associated with power source components, then a verification indicator may be stored in association with corresponding associated received energy generation data. Optionally, a corresponding amount of a cryptocurrency (e.g., a “green coin”) may be awarded to the producer of the green energy, based on the amount of verified green energy produced. Such an award and transfer is discussed elsewhere herein in greater detail.

Optionally, in addition or instead, the authentication component 214 may verify that the claimed amount of energy output purported to be from a green energy source at a given site comports with configuration data associated with the site and/or environmental data. For example, the configuration data may include, for a photovoltaic (PV) power source, the number of PV panels, the size of the PV panels, the efficiency of the PV panels, and/or the like. By way of further example, the configuration data may include, for a wind turbine farm power source, the number of wind turbines, their rated energy output, the blade radius, the mast height, and/or the like. The environmental data (which may be acquired from third party data sources, sensors, and/or the like) may include, by way of example, cloud cover, wind speed, air density, sun position, time of year, etc.

For example, given a known size and efficiency of a photovoltaic array, knowing the expected kilowatt-hours per square meter, knowing the number of photovoltaic arrays, knowing the position of the sun, knowing the time of year, and knowing the cloud cover, a model may be used to predict the power output of the photovoltaic array(s) (e.g., in watts). Similarly, given known wind conditions (e.g., as determined from wind sensors or as predicted based on historical data for the site given the time of year, the time of day, optionally using current data such as temperature, humidity, and/or the like) a model may be used to predict the power output of the wind turbine(s) (e.g., in watts).

$$E = A * r * H * PR$$

Where:
E=Energy (kWh)
A=Total solar panel area (m2)
r=solar panel yield or efficiency (%), given by the ratio: electrical power (in kWp) of one solar panel divided by the area of one panel
H=Annual average solar radiation on tilted panels (excluding shadings)
PR=Performance ratio, coefficient for losses (e.g., in a range between 0.5 and 0.9), which may account for performance regardless of panel orientation or tilt, and which may include losses

If the reported power output is more than a threshold amount greater than predicted, a determination may be made that the reported power output is not accurate and may be faked or forged reporting, and a verification failure indicator may be stored in associated with corresponding associated received energy generation data.

If the reported power output is equal to or less than the threshold amount greater than predicted, a determination may be made that the reported power output is accurate, and a verification success indicator may be stored in associated with corresponding associated received energy generation data. Optionally, a corresponding amount of a cryptocurrency (e.g., a “green coin”) may be awarded to the producer of the green energy, based on the amount of verified green energy produced.

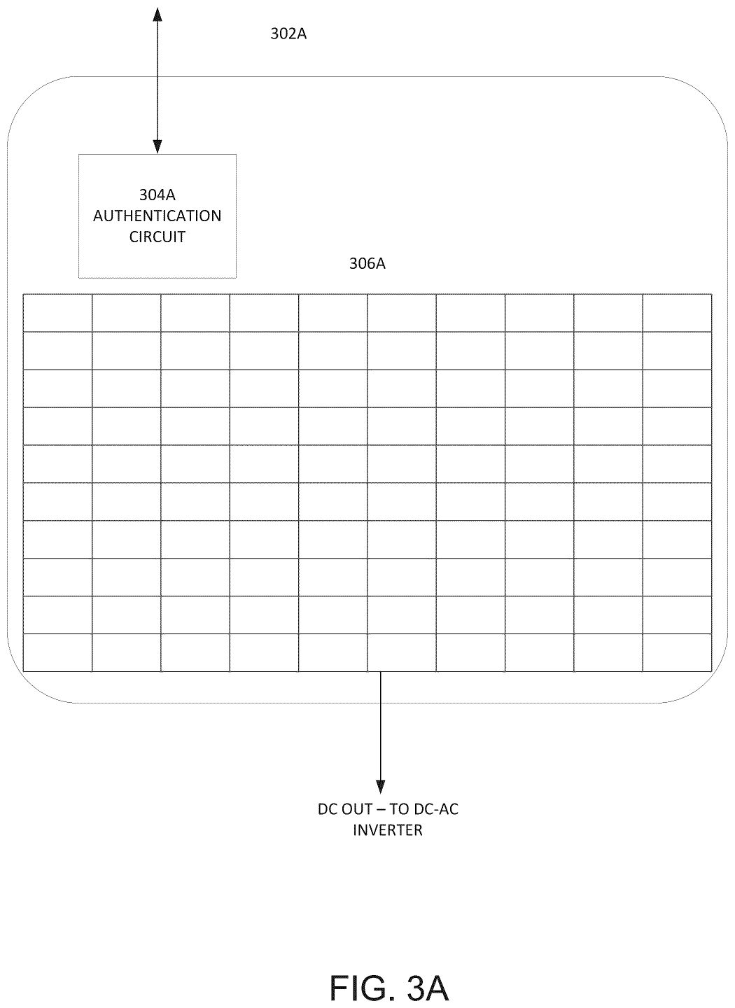

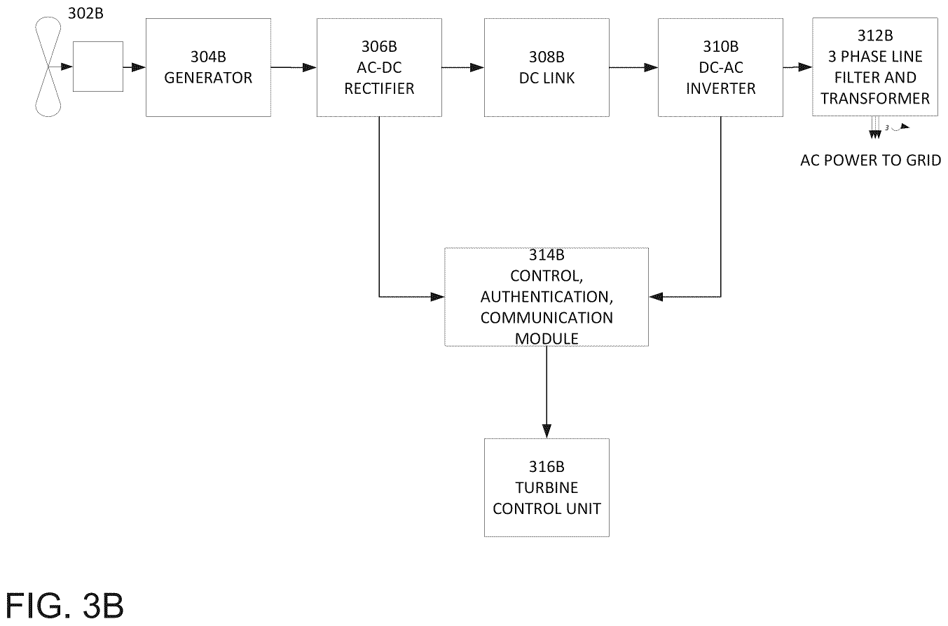

FIG. 3A illustrates an example PV panel 302A with a solar array 306A and an authentication circuit 304A mounted thereto. The authentication circuit 304A can transmit the authentication data (e.g., the unique identifier) and optionally some or all of the other power source configuration data described herein via a network interface (e.g., a wired or wireless network interface) to a destination, such as the energy tracking system 104. Optionally, the authentication and/or other data may be encrypted using a key or otherwise prior to transmission as similarly discussed elsewhere herein. The DC electrical power generated by the solar array 306A may be transmitted (e.g., via a powerline) to a DC to AC inverter. Optionally, in addition or instead of having the authentication circuit 304A mounted to the PV panel 302A, an instantiation of an authentication circuit may be mounted to the DC to AC inverter, which may provide some or all of the authentication data and related data as described herein to the energy tracking system 104.

FIG. 3B illustrates an example wind turbine power generator that converts kinetic energy into electrical energy through the use of a generator. There may be an array of wind turbine power generators at a given location. A wind turbine blade 302B may be coupled to a generator 304B. The blade 302B rotates with the wind, turning the generator 304B which in turn generates AC electricity. An AC to DC rectifier 306B converts relatively noisy AC power from the generator to DC power. A DC link 308B provides the DC power to a DC to AC inverter 310B that in turn converts the DC power to clean AC power. The output of the DC to AC inverter 310B to a three phase line filter and transformer 312B (to provide voltage conversion from low voltage to higher voltage for transmission), which in turn provide three phase AC power to the power grid.

A control, authentication, communication module 314B controls the switching of the foregoing device (e.g., via a digital signal processor), and communicates authentication data (and optionally some or all of the other wind turbine data discussed herein) to a turbine control unit 316B. The control, authentication, communication module 314B can transmit the authentication data (e.g., the unique identifier) and optionally some or all of the other power source configuration data described herein via a network interface (e.g., a wired or wireless network interface) to a destination, such as the energy tracking system 104 (directly or via the turbine control unit 316B). Optionally, the authentication and/or other data may be encrypted using a key or otherwise prior to transmission as similarly discussed elsewhere herein. The control, authentication, communication module 314B may also control the generator speed, blade angle adjustment, and/or rotation of the entire wind turbine.

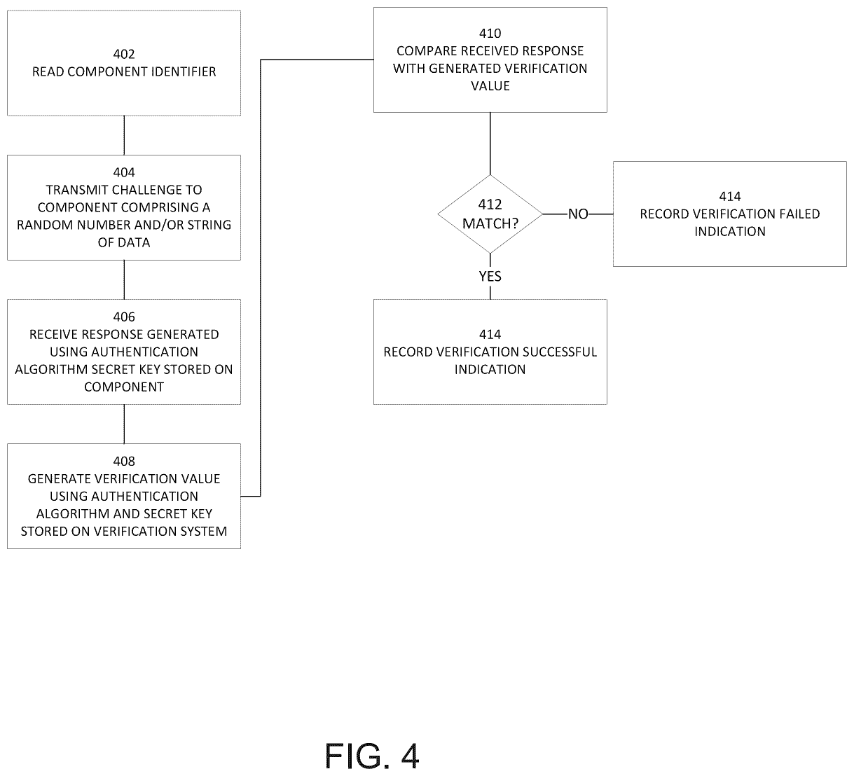

Referring now to FIG. 4, an example process configured to determine whether a report of an amount of energy has been produced using a green energy source is authentic and/or accurate. As will be discussed, a challenge-response authentication may be utilized composed of a question and a response, where only an authorized component (e.g., mounted to a green energy source, such as a PV panel, a wind turbine generator, an inverter, and/or the like) will be able to provide a valid response.

At block 402, an energy tracking system receives a unique identifier that purports to be from a component associated with a green energy source (e.g., purported to be mounted to a green energy source, such as a PV panel, a wind turbine generator, an inverter, and/or the like). At block 404, a challenge is transmitted to the component, which may comprise a random number and/or a string of data. At block 406, a response is received from the purported component, where the response is to be generated based in part on the challenge, along with other factors such as a secret key, password, and/or cryptographic key.

At block 408, the energy tracking system (which knows the secret key, password, and/or cryptographic keys used in the calculation of the response) performs the same calculation via an authentication algorithm using the challenge and, at block 410, compares the result with the response sent by the purported component.

At block 412, a determination is made as to whether the calculated result generated by the energy tracking system matches the response sent by the purported component. If they match, at block 414, a verification success indication may be stored in a record associated with the component. If the calculated result generated by the energy tracking system does not match the response sent by the purported component a verification failure indication may be stored in a record associated with the component. Optionally, a report may be generated that indicates which components identities were successfully verified and which components identities were not successfully verified. The report may be electronically transmitted to one or more specified destinations (e.g., via an email, via a download, via a messaging service message, and/or the like).

Advantageously, the challenge may optionally be unique for each component authentication attempt. This prevents attackers from using previously intercepted responses to gain unauthorized access. Further, advantageously, the secret key, password, and/or cryptographic key used in the response calculation is never transmitted over the network, making it harder for malicious actors to obtain it through eavesdropping.

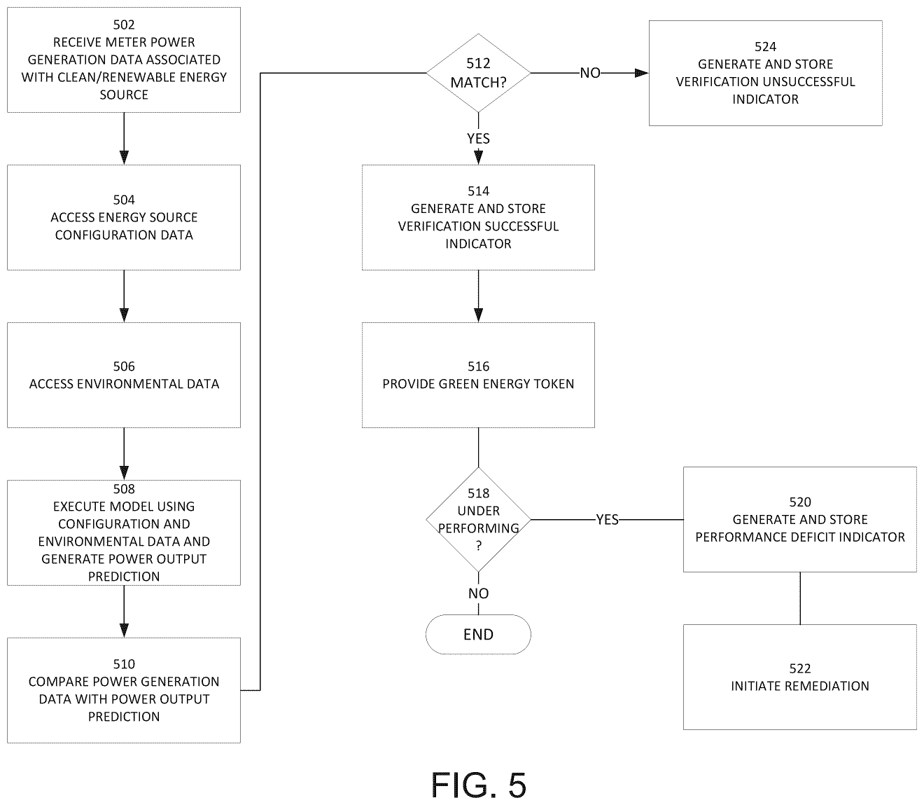

Referring now to FIG. 5, an example process is illustrated configured to utilize environmental data to determine whether a reported amount of green power generation is plausible. The process of FIG. 5 may optionally be performed in conjunction with (e.g., before, in parallel with, or after) the process of FIG. 4. Optionally, if the authentication process of FIG. 4 results in a non-verification indication, the process of FIG. 5 is skipped to conserve computer resources. The process may optionally be performed using an energy tracking system, such as discussed elsewhere herein.

At block 502, meter power generation data associated with a green (clean/renewable) energy source identifier (e.g., configured to uniquely identify an energy source component) is received (e.g., from a device purporting to be an authentication circuit) at an energy tracking system as similarly discussed elsewhere herein. The meter generation data may include a claimed green source energy output (e.g., a quantity of watts, kilowatts, megawatts, watt hours, kilowatt hours, megawatt hours). The energy component may be located (or purportedly located) at a given site at which one or more arrays of energy source components (e.g., solar panels, wind turbine, etc.) may be located (or purportedly located. Optionally, multiple identifiers may be received, wherein each identifier is associated with a respective energy source component (or multiple energy source components), In addition, associated data may be received with the identifier, such as an energy source component type (e.g., photovoltaic panel, wind turbine), rated energy output, efficiency, blade radius (e.g., for a wind turbine), mast height (e.g., for a wind turbine), and/or other such data.

At block 504, the energy tracking system may access source configuration data (e.g., from local or remote memory) that may identify previously stored configuration data corresponding to the site at which the green energy source is located. For example, the configuration data may include the number of energy source components of a given type (e.g., photovoltaic panel, wind turbine, etc.), instantaneous rated energy output (e.g., in watts, kilowatts, or megawatts) for a given energy source component, rated energy output over a given period of time (e.g., watt hours, kilowatt hours, megawatt hours), efficiency, blade radius (e.g., for a wind turbine), mast height (e.g. for a wind turbine), and/or other such data.

At block 506, environmental data is accessed. The environmental data may optionally include real time data accessed from sensors local to the site and/or third party sites, and may include cloud cover, wind speed, air density, sun position, time of year, etc. Such environmental data may be obtained from satellites, light sensors (e.g., located at a given green energy source site), wind sensors (e.g., located at a given green energy source site) and/or the like. The environmental data may also include historical data for the site and/or a similar location.

At block 508, a model may be executed using some or all of the energy source configuration data and environmental data to generate an energy power output prediction (e.g., in watts, kilowatts, megawatts, watt hours, kilowatt hours, megawatt hours) for a given energy source component or for a plurality of energy source components (e.g., for an entire site of energy components, or a subset thereof).

At block 510, the received power generation data (the received claimed green source energy output) may be compared with the energy power output prediction. A determination may be made at block 512 as to whether the received power generation data (the received claimed green source energy output quantity) matches the energy power output prediction (e.g., where there is less than a threshold difference between the two, such as less than a 5%, 10%, or 15% difference).

If the received power generation data matches the energy power output prediction (e.g., where there is less than a threshold difference between the two, such as less than a 5%., 10%, or 15% difference), at block 514 a verification successful indicator is stored in memory (optionally in association with the given component or plurality of components). Optionally, at block 516, green token, such as a corresponding amount of a cryptocurrency (e.g., a “green coin”), may be awarded to the producer of the green energy, based on the amount of verified green energy produced.

For example, the provider of the green coin may have minted the green coin or may have acquired the cryptocurrency (to be provided to the producer of the green energy) from another source. The green coin may be transmitted to a cryptocurrency electronic wallet associated with the energy producer. For example, using a transfer function of a cryptocurrency electronic wallet of the giver of the green coin, where the coin provider may enter the energy producer's (or other recipient's) address, specify the amount of cryptocurrency to be provided (and optionally cryptocurrency type), and may confirm the transaction. Optionally, a separate electronic communication may be transmitted to the energy producer informing the energy producer of the date, time, amount, and/or green coin cryptocurrency type transferred to the energy producer's wallet,

Optionally, at block 518, a determination may be made as to whether the power source is under-producing energy. For example, if the received claimed green source energy output is less than a specified threshold amount less than the energy power output prediction, it may indicate that the power source's ability to generate energy has been adversely impacted (e.g., by dust or sand on PV panels, by a component failure in a wind turbine, etc.). If a determination is made that the power source is under-producing, at block 520, a performance deficit indicator may be generated and stored in memory. At block 522, a remediation process may be initiated. For example, the remediation process may involve the cleaning of PV panels, component replacement, and/or the like.

If the received power generation data (the received claimed green source energy output) fails to match the energy power output prediction (e.g., where there is more than a threshold difference between the two, such as less than a 5%, 10%, or 15% difference), at block 524 a verification failure indicator is optionally, stored in memory (optionally in association with the given component or plurality of components),

Optionally, a report may be generated that indicates which claimed green source energy outputs were successfully verified and which claimed green source energy outputs were not successfully verified. Optionally, a given claimed green source energy output and a calculated energy output may be included in the report. Optionally, the actual and/or percentage difference between a given claimed green source energy output and a calculated energy output may be included in the report. The report may be electronically transmitted to one or more specified destinations (e.g., via an email, via a download, via a messaging service message, and/or the like).

Thus, systems and methods are disclosed configured to determine if power claimed to be produced by a given energy source (e.g., a green energy source) actually was produced by the given energy source. Furthermore, systems and methods are disclosed configured to determine if power claimed to be produced by a given energy source indicates that the energy source is under-producing. An aspect of the present disclosure relates to methods and systems that authenticate a power source. Encrypted authentication data is received purporting to be from a device associated with a power generation source at a location. A determination is made as to whether the authentication data is valid. Power quantity data purportedly generated by the power generation source is received. Configuration data associated with the power generation source and environmental data associated with the location are accessed. The configuration data and the environmental data are used to calculate a predicted power quantity data for the power generation source. The predicted power quantity data is compared with the received power quantity data to determine if they correspond. If the predicted power quantity data corresponds with the received power quantity data, and the authentication data purporting to be from the device associated with the power generation source is valid, a corresponding validation indicator is generated and optionally an electronic token is transferred to a first destination.

An aspect of the present disclosure relates to an energy generation authentication and verification computer system, the computer system comprising: a network interface; at least one processing device operable to: receive, via the network interface, encrypted authentication data purporting to be from a first device associated with a power generation source at a first location; determine if the encrypted authentication data purporting to be from the first device associated with the power generation source is valid; receive, via the network interface, power quantity data purportedly generated by the power generation source at the first location; access configuration data associated with the power generation source; access environmental data associated with the first location; use the accessed configuration data associated with the power generation source and the accessed environmental data associated with the first location to calculate a predicted power quantity data for the power generation source at the first location; compare the predicted power quantity data with the received power quantity data to determine if they correspond; at least partly in response to determining that the predicted power quantity data corresponds with the received power quantity data, and that the encrypted authentication data purporting to be from the first device associated with the power generation source is valid, generate a corresponding validation indicator and transfer an electronic token to a first destination.

Optionally, the power generation source comprises a photovoltaic panel and the configuration data associated with the power generation source comprises solar panel size data and solar panel efficiency data. Optionally, the power generation source comprises a wind turbine, and the configuration data associated with the power generation source comprises blade size data. Optionally, the environmental data comprises cloud cover, sun position, and time of year. Optionally, the environmental data comprises wind speed. Optionally, the computer system is configured to initiate a power generation remediation process at least partly in response to a determination that a second received power quantity data is less than a second predicted power quantity data by at least a threshold amount.

An aspect of the present disclosure relates to a computer implemented method, the method comprising: receiving, at a computer system, authentication data purporting to be from a first device associated with a power generation source at a first location; determining if the authentication data purporting to be from the first device associated with the power generation source is valid; receiving power quantity data purportedly generated by the power generation source at the first location; accessing configuration data associated with the power generation source; accessing environmental data associated with the first location; using the accessed configuration data associated with the power generation source and the accessed environmental data associated with the first location to calculate a predicted power quantity data for the power generation source at the first location; comparing the predicted power quantity data with the received power quantity data to determine if they correspond; at least partly in response to determining that the predicted power quantity data corresponds with the received power quantity data, and that the authentication data purporting to be from the first device associated with the power generation source is valid, generating a corresponding validation indicator and transferring an electronic token to a first destination.

Optionally, the power generation source comprises a photovoltaic panel and the configuration data associated with the power generation source comprises solar panel size data and solar panel efficiency data. Optionally, the power generation source comprises a wind turbine, and the configuration data associated with the power generation source comprises blade size data. Optionally, the environmental data comprises cloud cover, sun position, and time of year. Optionally, the environmental data comprises wind speed. Optionally, the method further comprises initiating a power generation remediation process at least partly in response to a determination that a second received power quantity data is less than a second predicted power quantity data by at least a threshold amount.

An aspect of the present disclosure relates to a computer system comprising: a network interface; at least one processing device operable to: receive, via the network interface, authentication data purporting to be from a first device associated with a power generation source at a first location (e.g., wherein the first device is physically coupled to a photovoltaic panel, a wind turbine, or an inverter); determine if the authentication data purporting to be from the first device associated with the power generation source is valid; at least partly in response to determining that the data purporting to be from the first device associated with the power generation source is valid, generating a corresponding validation indicator.

Optionally, the computer system is configured to: receive, via the network interface, power quantity data purportedly generated by the power generation source at the first location; access configuration data associated with the power generation source; access environmental data associated with the first location; use the accessed configuration data associated with the power generation source and the accessed environmental data associated with the first location to calculate a predicted power quantity data for the power generation source at the first location; compare the predicted power quantity data with the received power quantity data to determine if they correspond; wherein the validation indicator is generated at least partly in response to determining that the predicted power quantity data corresponds with the received power quantity data.

Optionally, the computer system is configured to: receive, via the network interface, power quantity data purportedly generated by the power generation source at the first location; access configuration data associated with the power generation source; access environmental data associated with the first location; use the accessed configuration data associated with the power generation source and the accessed environmental data associated with the first location to calculate a predicted power quantity data for the power generation source at the first location; compare the predicted power quantity data with the received power quantity data to determine if they correspond; wherein the validation indicator is generated at least partly in response to determining that the predicted power quantity data corresponds with the received power quantity data, wherein the power generation source comprises a photovoltaic panel and the configuration data associated with the power generation source comprises solar panel size data and solar panel efficiency data. Optionally, the power generation source comprises a wind turbine, and the configuration data associated with the power generation source comprises blade size data. Optionally, the computer system is configured to: receive, via the network interface, power quantity data purportedly generated by the power generation source at the first location; access configuration data associated with the power generation source; access environmental data associated with the first location; use the accessed configuration data associated with the power generation source and the accessed environmental data associated with the first location to calculate a predicted power quantity data for the power generation source at the first location; compare the predicted power quantity data with the received power quantity data to determine if they correspond; wherein the validation indicator is generated at least partly in response to determining that the predicted power quantity data corresponds with the received power quantity data, wherein the environmental data comprises cloud cover, sun position, and time of year. Optionally, the computer system is configured to: receive, via the network interface, power quantity data purportedly generated by the power generation source at the first location; access configuration data associated with the power generation source; access environmental data associated with the first location; use the accessed configuration data associated with the power generation source and the accessed environmental data associated with the first location to calculate a predicted power quantity data for the power generation source at the first location; compare the predicted power quantity data with the received power quantity data to determine if they correspond; wherein the validation indicator is generated at least partly in response to determining that the predicted power quantity data corresponds with the received power quantity data, wherein the environmental data comprises wind speed. Optionally, the computer system is configured to initiate a power generation remediation process at least partly in response to a determination that a second received power quantity data is less than a second predicted power quantity data by at least a threshold amount.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources, or may comprise a standalone system. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone or mobile application, computer application, a short messaging service message (e.g., SMS, MMS, etc.), instant messaging, email, push notification, audibly, via haptic feedback, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, microphone, camera, touch pad, etc.), network interfaces, etc.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

What is claimed is:

1. An energy generation authentication and verification computer system, the computer system comprising:
a network interface;
at least one processing device operable to:
receive, via the network interface, encrypted authentication data purporting to be from a first device associated with a power generation source at a first location;
determine if the encrypted authentication data purporting to be from the first device associated with the power generation source is valid;
receive, via the network interface, power quantity data purportedly generated by the power generation source at the first location;
access configuration data associated with the power generation source;
access environmental data associated with the first location;
use the accessed configuration data associated with the power generation source and the accessed environmental data associated with the first location to calculate a predicted power quantity data for the power generation source at the first location;
compare the predicted power quantity data with the received power quantity data to determine if they correspond;
at least partly in response to determining that the predicted power quantity data corresponds with the received power quantity data, and that the encrypted authentication data purporting to be from the first device associated with the power generation source is valid, generate a corresponding validation indicator and transfer an electronic token to a first destination.

2. The energy generation verification computer system as defined in claim 1, wherein the power generation source comprises a photovoltaic panel and the configuration data associated with the power generation source comprises solar panel size data and solar panel efficiency data.

3. The energy generation verification computer system as defined in claim 1, wherein the power generation source comprises a wind turbine, and the configuration data associated with the power generation source comprises blade size data.

4. The energy generation verification computer system as defined in claim 1, wherein the environmental data comprises cloud cover, sun position, and time of year.

5. The energy generation verification computer system as defined in claim 1, wherein the environmental data comprises wind speed.

6. The energy generation verification computer system as defined in claim 1, wherein the computer system is configured to initiate a power generation remediation process at least partly in response to a determination that a second received power quantity data is less than a second predicted power quantity data by at least a threshold amount.

7. A computer implemented method, the method comprising:
receiving, at a computer system, authentication data purporting to be from a first device associated with a power generation source at a first location;
determining, using the computer system, if the authentication data purporting to be from the first device associated with the power generation source is valid;
receiving power quantity data purportedly generated by the power generation source at the first location;
accessing configuration data associated with the power generation source;
accessing environmental data associated with the first location;
using the accessed configuration data associated with the power generation source and the accessed environmental data associated with the first location to calculate, using the computer system, a predicted power quantity data for the power generation source at the first location;
comparing the predicted power quantity data with the received power quantity data to determine if they correspond;
at least partly in response to determining that the predicted power quantity data corresponds with the received power quantity data, and that the authentication data purporting to be from the first device associated with the power generation source is valid, generating a corresponding validation indicator and transferring an electronic token to a first destination.

8. The computer implemented method as defined in claim 7, wherein the power generation source comprises a photovoltaic panel and the configuration data associated with the power generation source comprises solar panel size data and solar panel efficiency data.

9. The computer implemented method as defined in claim 7, wherein the power generation source comprises a wind turbine, and the configuration data associated with the power generation source comprises blade size data.

10. The computer implemented method as defined in claim 7, wherein the environmental data comprises cloud cover, sun position, and time of year.

11. The computer implemented method as defined in claim 7, wherein the environmental data comprises wind speed.

12. The computer implemented method as defined in claim 7, the method further comprising initiating a power generation remediation process at least partly in response to a determination that a second received power quantity data is less than a second predicted power quantity data by at least a threshold amount.

13. A computer system comprising:
a network interface;
at least one processing device operable to:
receive, via the network interface, authentication data purporting to be from a first device associated with a power generation source at a first location, wherein the first device is physically coupled to a photovoltaic panel, a wind turbine, or an inverter;
determine if the authentication data purporting to be from the first device associated with the power generation source is valid;
at least partly in response to determining that the data purporting to be from the first device associated with the power generation source is valid, generating a corresponding validation indicator.

14. The computer system as defined in claim 13, wherein the computer system is configured to:
receive, via the network interface, power quantity data purportedly generated by the power generation source at the first location;
access configuration data associated with the power generation source;
access environmental data associated with the first location;
use the accessed configuration data associated with the power generation source and the accessed environmental data associated with the first location to calculate a predicted power quantity data for the power generation source at the first location;
compare the predicted power quantity data with the received power quantity data to determine if they correspond;
wherein the validation indicator is generated at least partly in response to determining that the predicted power quantity data corresponds with the received power quantity data.

15. The computer system as defined in claim 13, wherein the computer system is configured to:
receive, via the network interface, power quantity data purportedly generated by the power generation source at the first location;
access configuration data associated with the power generation source;
access environmental data associated with the first location;
use the accessed configuration data associated with the power generation source and the accessed environmental data associated with the first location to calculate a predicted power quantity data for the power generation source at the first location;
compare the predicted power quantity data with the received power quantity data to determine if they correspond;
wherein the validation indicator is generated at least partly in response to determining that the predicted power quantity data corresponds with the received power quantity data, and
wherein the power generation source comprises a photovoltaic panel and the configuration data associated with the power generation source comprises solar panel size data and solar panel efficiency data.

16. The energy generation verification computer system as defined in claim 13, The computer system as defined in claim 13, wherein the computer system is configured to:
receive, via the network interface, power quantity data purportedly generated by the power generation source at the first location;
access configuration data associated with the power generation source;
access environmental data associated with the first location;
use the accessed configuration data associated with the power generation source and the accessed environmental data associated with the first location to calculate a predicted power quantity data for the power generation source at the first location;
compare the predicted power quantity data with the received power quantity data to determine if they correspond;
wherein the validation indicator is generated at least partly in response to determining that the predicted power quantity data corresponds with the received power quantity data, and
wherein the power generation source comprises a wind turbine, and the configuration data associated with the power generation source comprises blade size data.

17. The computer system as defined in claim 13, wherein the computer system is configured to:
receive, via the network interface, power quantity data purportedly generated by the power generation source at the first location;
access configuration data associated with the power generation source;
access environmental data associated with the first location;
use the accessed configuration data associated with the power generation source and the accessed environmental data associated with the first location to calculate a predicted power quantity data for the power generation source at the first location;
compare the predicted power quantity data with the received power quantity data to determine if they correspond;
wherein the validation indicator is generated at least partly in response to determining that the predicted power quantity data corresponds with the received power quantity data,
wherein the environmental data comprises cloud cover, sun position, and time of year.

18. The computer system as defined in claim 13, wherein the computer system is configured to:
receive, via the network interface, power quantity data purportedly generated by the power generation source at the first location;
access configuration data associated with the power generation source;
access environmental data associated with the first location;
use the accessed configuration data associated with the power generation source and the accessed environmental data associated with the first location to calculate a predicted power quantity data for the power generation source at the first location;
compare the predicted power quantity data with the received power quantity data to determine if they correspond;
wherein the validation indicator is generated at least partly in response to determining that the predicted power quantity data corresponds with the received power quantity data,
wherein the environmental data comprises wind speed.

19. The computer system as defined in claim 13, wherein the computer system is configured to initiate a power generation remediation process at least partly in response to a determination that a second received power quantity data is less than a second predicted power quantity data by at least a threshold amount.
